(19) United States
(12) Patent Application Publication
(10) Pub. No.: US 2014/0359426 A1
(43) Pub. Date: Dec. 4, 2014

(54) METHOD AND APPARATUS FOR PROVIDING SUGGESTION FOR BROWSER ADDRESS BAR INPUT, BROWSER AND TERMINAL THEREOF

(71) Applicant: TENCENT TECHNOLOGY (SHENZHEN) COMPANY LIMITED, Shenzhen (CN)

(72) Inventor: Ningjun DOU, Shenzhen (CN)

(21) Appl. No.: 14/449,309

(22) Filed: Aug. 1, 2014

Related U.S. Application Data
(63) Continuation of application No. PCT/CN2013/089427, filed on Dec. 13, 2013.

(30) Foreign Application Priority Data
May 31, 2013 (CN) 201310213425.6

(51) Int. Cl. G06F 17/22; G06F 17/30; H04L 29/06

(52) U.S. Cl. CPC G06F 17/2247; H04L 67/42; G06F 17/30861
USPC 715/234

(57) ABSTRACT

The present disclosure generally provides a method and apparatus for providing a suggestion for a browser address bar input, and a corresponding browser and terminal. The method includes: obtaining a string that is input in an address bar of a browser; obtaining a primary address and an associational address for webpages that respectively include the string from a local and/or a backstage server; displaying in a suggestion area of the browser the primary address and the associational address. The primary address and the associational address are obtained according to the inputted string and displayed accordingly. Adequate options can therefore be provided for users to select when entering a string in an address bar of a browser.

### CROSS-REFERENCE TO RELATED APPLICATIONS

The present application is a continuation application of International Application PCT/CN2013/089427, filed Dec. 13, 2013, and claims foreign priority to Chinese application 201310213425.6 filed May 31, 2013, and which is incorporated herein by reference in their entireties.

### FIELD OF THE INVENTION

The present disclosure relates generally to the field of internet technology, and particularly, to a method and apparatus for providing suggestion for browser address bar input, and browser and terminal thereof.

### BACKGROUND OF THE INVENTION

Users are getting accustomed to obtain required information by visiting the internet through a browser. Browser is a kind of application software which is able to display HTML (Hyper Text Markup Language) file contents of webpage servers or file systems, and allows interaction between users and the files. Typically, browsers interact with the webpage servers through Hyper Text Transfer Protocol (HTTP) for obtaining the webpages that are designated by Universal Resource Locator (URL) and have file formats of HTML. Usually, the webpages are indicated in HTTP protocol through Multipurpose Internet Main Extensions (MIME).

In a conventional browser, the user inputs a string into an address bar of the browser. As the user inputs the string, only those URL items that include the inputted string would be suggested as options to the user as selections available to the user. For instance, in a situation that “baidu” is inputted to an address bar of a conventional browser, an item “www.baidu.com” would be suggested as the input option. It is hereby discovered by the inventor that conventional browsers need improvement when the user enters a string into the address bar.

Moreover, conventional browsers provide very few items as input options after the string is inputted, thereby resulting in inadequate choices provided to the user.

### SUMMARY OF THE INVENTION

Accordingly, it is necessary to provide a method, an apparatus, a browser and a terminal that could provide adequate options for browser address bar input for users to select from.

A method for providing suggestion for browser address bar input includes:

obtaining inputted strings in an address bar of a browser;

obtaining primary address and associational address for webpages that respectively include the inputted strings from a local and/or a backstage server;

displaying in a suggestion area of the browser the primary address and the associational address.

A method for providing suggestion for browser address bar input includes:

obtaining inputted strings in an address bar of a browser, wherein the inputted string is void;

selecting predetermined amount of history records from a local and/or a backstage server according to a timing order;

displaying in a suggestion area of the browser the selected predetermined amount of history records.

An apparatus for providing suggestion for browser address bar input includes:

an input module configured to obtain inputted strings in an address bar of a browser;

an obtaining module configured to obtain primary address and associational address for webpages that respectively include the inputted strings from a local and/or a backstage server;

a display module configured to display in a suggestion area of the browser the primary address and the associational address.

An apparatus for providing suggestion for browser address bar input includes:

an input module configured to obtain inputted strings in an address bar of a browser, wherein the inputted string is void;

an obtaining module configured to select predetermined amount of history records from a local and/or a backstage server according to a timing order;

a display module configured to display in a suggestion area of the browser the selected predetermined amount of history records.

It is also provided by the present disclosure a browser that includes the above apparatus for providing suggestion for browser address bar input.

It is also provided by the present disclosure a terminal for executing the above method for providing suggestions for a browser address bar input.

It is also provided by the present disclosure a terminal that includes a browser, wherein the browser includes the above apparatus for providing suggestion for browser address bar input.

According to the described method, apparatus for providing suggestion for browser address bar input, and corresponding browser and terminal, primary address and associational address for webpages respectively including the inputted strings are obtained according to the inputted strings and displayed accordingly. Adequate options could therefore be provided for users to select from, according to the associational inputted strings.

### BRIEF DESCRIPTION OF THE DRAWINGS

FIG. 1 is a flow diagram of a method for providing a suggestion for a browser address bar input according to an exemplary embodiment;

FIG. 2 is a flow diagram of a method for providing a suggestion for a browser address bar input according to another exemplary embodiment;

FIG. 3 is a flow diagram of a method for providing a suggestion for a browser address bar input according to still another exemplary embodiment;

FIG. 4 is a flow diagram of a process for obtaining an original address and an original associational address for webpages that respectively include the inputted strings in webpage links or webpage titles thereof;

FIG. 5 is a flow diagram of a method for providing a suggestion for a browser address bar input according to still another exemplary embodiment;

FIG. 6 is a block diagram of an apparatus for providing a suggestion for a browser address bar input according to an exemplary embodiment;

FIG. 7 is an internal block diagram of the obtaining module 640 of FIG. 6;

FIG. 8 is a block diagram of an apparatus for providing a suggestion for a browser address bar input according to another exemplary embodiment;

FIG. 9 is a block diagram of a terminal according an exemplary embodiment.

### DESCRIPTION OF THE PREFERRED EMBODIMENTS

The following embodiments and accompanying drawings would be described in detail for explaining the method and apparatus for updating applications in accordance with the present disclosure.

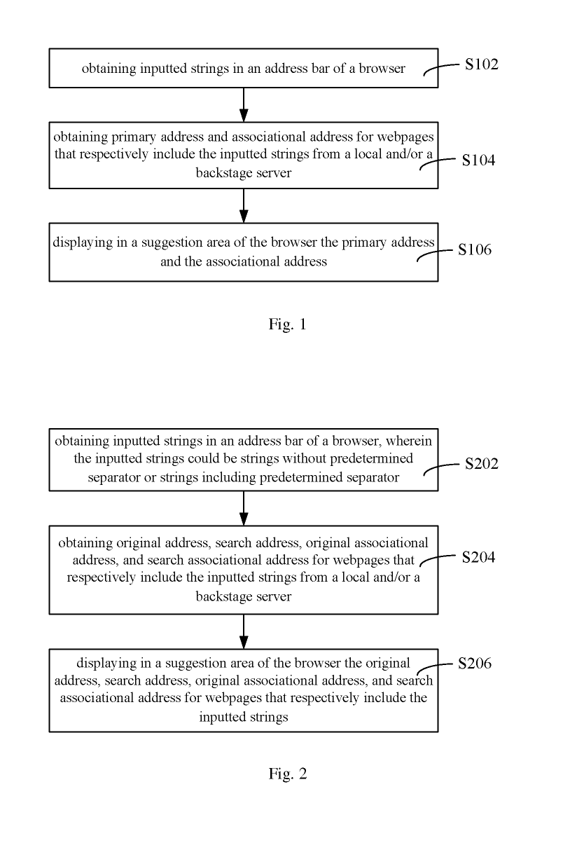

Referring to FIG. 1, a flow chart of a method for providing a suggestion for a browser address bar input is illustrated. The method could be implemented on browsers that are installed in terminals. The terminals could be desktop computers, laptop computers, palm computers, or smart phones. The method includes:

Step S102, obtaining inputted strings in an address bar of a browser.

In detail, a user launches the browser in the terminal, and inputs strings in the address bar thereof through touch screens or press keys. The string could be one of the below types:

(1) String without Predetermined Separator

Specifically, the predetermined separator could be “.” or any separator in a webpage address for separating characters. An example for a string without predetermined separator could be “abc”.

(2) String Including Predetermined Separator

An example for a string with predetermined separator could be “abc.cd”.

(3) String Including Specified Header Character

In detail, the specified header character could be “http:” or “www.”, and inclusion of the header character would be indicative that the user is in intension of visiting particular URL.

Step S104, obtaining primary address and associational address for webpages that respectively include the inputted strings from a local and/or a backstage server.

Specifically, the inputted strings could be, for example, Chinese characters, English characters, numbers, symbols, and the combination thereof. Take an example of inputting strings “xxx”, the primary address for webpages that include the inputted strings could be xxx*.*, while the associational address for webpages that includes the inputted strings could be URLs like 3g.xxx* or m.xxx*, wherein “*” indicates a wildcard.

The primary address for webpages that include the inputted strings could be original address or search address for webpages that respectively include the inputted strings. Associational address for webpages that include the inputted strings could be original associational address or search associational address for webpages that respectively include the inputted strings.

The original address is the webpage address that the inputted strings are directly supplemented by characters like .com or .cn. For example, the inputted strings “baidu” could be directly supplemented to be the original address “www.baidu.com”.

The search address shall indicate a search implementation on the inputted strings, and shall mean the webpage address that includes a search result of the inputted strings upon corresponding search implementation is selected. A suggestion for searching the inputted strings is provided, for example, “search for: xxx”. For instance, if the inputted string is “baidu”, corresponding search address shall be, after search implementation on “baidu” is selected, indicative for guiding to a webpage wherein a plurality of searching results on “baidu” are included. After any one of the searching result is selected, corresponding webpage would be able to be accessed.

The original associational address shall mean the webpage address that is obtained through associational suggestion and that includes the inputted strings and corresponding associational characters. Taking the inputted strings “m.s” as an example, the original associational address for webpages that include the inputted strings could be “m.sohu.com” or “m.sogou.com”, etc.

The search associational address shall mean the address of webpage in which multiple associational search results are included through search implementation on the associational inputted strings. For example, the inputted strings are “m.s”, the search associational address is the webpage address in which “m.sohu” is searched to obtained. After said “m.sohu” is selected, a webpage including the result for searching “m.sohu” strings could be accessed, and subsequently, after any one of the searching results is selected, corresponding webpage would be able to be accessed.

Step S106, displaying in a suggestion area of the browser the primary address and the associational address.

Specifically, a list that includes the primary address and the associational address would be displayed in the suggestion area of the browser. The suggestion area of the browser preferably could be a determined box area over or below the address bar. The suggestion area could be hidden, after the user inputs strings in the address bar, the suggestion area would display automatically.

Additionally, the primary address and the associational address could be ranked before being displayed. The primary address could be ranked to be in front of the associational address.

According to the described method for providing suggestion for browser address bar input, primary address and associational address for webpages respectively include the inputted strings are obtained according to the inputted strings and displayed accordingly. Adequate options could therefore be provided for users to select from, according to the associational inputted strings.

Further, referring to FIG. 2, a method for providing a suggestion for a browser address bar input would include:

Step S202, obtaining inputted strings in an address bar of a browser, wherein the inputted strings could be strings without predetermined separator or strings including predetermined separator.

Step S204, obtaining original address, search address, original associational address, and search associational address for webpages that respectively include the inputted strings from a local and/or a backstage server.

Specifically, either the local or the backstage server would include history records for webpage addresses. The history records include original records and search records. The original records stores webpage addresses that the user has visited, including the original address and the original associational address. The search records stores webpage addresses for the searches that the user has conducted, including the search address and the search associational address.

Search associational address shall mean the webpage address in which multiple search result on the inputted strings and the associational strings thereof are included. For example, the inputted strings are “baidu”, the associational strings thereof could be “maps”, and a search on “baidu maps” would accordingly be suggested with the format “search for: baidu maps”. If selected, a search result webpage would be accessed, and many webpage addresses that are corresponding to the search results would be presented, such as the webpage address for “baidu maps”, the wiki webpage address for “baidu maps”, etc.

Step S206, displaying in a suggestion area of the browser the original address, search address, original associational address, and search associational address for webpages that respectively include the inputted strings.

According to the described method for providing suggestion for browser address bar input, the original address, search address, original associational address, and search associational address for webpages respectively include the inputted strings are obtained according to the inputted strings and displayed accordingly. Adequate options could therefore be provided for users to select from, according to the associational inputted strings.

Additionally, if the inputted strings are strings including predetermined separator, associational strings would be separately obtained through associating strings before and after the predetermined separator. First, setting up associational database; after obtaining the strings including predetermined separator, the strings are divided into first strings and second strings respectively before and after the predetermined separator. First associational strings for the first strings and second associational strings for the second strings would subsequently be obtained from the associational database according to the first and second strings. Accordingly, original associational address and search associational address including the first strings and the first associational strings, the predetermined separator, and the second strings and the second associational strings would be concluded.

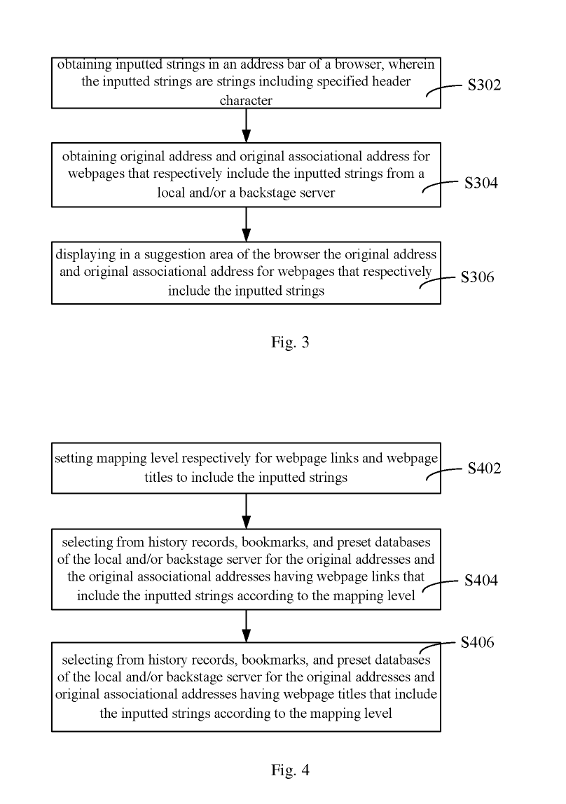

Further, referring to FIG. 3, a method for providing a suggestion for a browser address bar input would include:

Step S302, obtaining inputted strings in an address bar of a browser, wherein the inputted strings are strings including specified header character.

Specifically, the specified header character could be “http:” or “www.”, inclusion of the header character would be indicative that the user is in intension of visiting particular URL.

Step S304, obtaining original address and original associational address for webpages that respectively include the inputted strings from a local and/or a backstage server.

Specifically, either the local or the backstage server would include history records for webpage addresses. The history records include original records and search records. The original records stores webpage addresses that the user has visited, including the original address and the original associational address. The search records stores webpage addresses for the searches that the user has conducted, including the search address and the search associational address.

Step S306, displaying in a suggestion area of the browser the original address and original associational address for webpages that respectively include the inputted strings.

According to the described method for providing suggestion for browser address bar input, the original address and original associational address for webpages respectively include the inputted strings are obtained according to the inputted strings and displayed accordingly. Adequate options could therefore be provided for users to select from, according to the associational inputted strings.

Furthermore, according to an embodiment of the present disclosure, referring to FIG. 4, obtaining original address and original associational address for webpages that respectively include the inputted strings from a local and/or a backstage server would further include: obtaining original address and original associational address for webpages that respectively include the inputted strings in webpage links or webpage titles thereof from a local and/or a backstage server, which further includes:

Step S402, setting mapping level respectively for webpage links and webpage titles to include the inputted strings.

Specifically, domain name for a webpage link that starts with the inputted strings would be set with a higher mapping level than those sub-domains for a webpage link that starts with the inputted strings. A webpage title that starts with the inputted strings would be set with a higher mapping level than those webpage titles that include the inputted strings.

Step S404, selecting from history records, bookmarks, and preset databases of the local and/or backstage server for the original addresses and the original associational addresses having webpage links that include the inputted strings according to the mapping level.

Specifically, either the local or the backstage server would include history records for webpage addresses. The history records include original records and search records. The original records stores webpage addresses that the user has visited, including the original address and the original associational address. The search records stores webpage addresses for the searches that the user has conducted, including the search address and the search associational address.

Original addresses and original associational addresses that have webpage links starting with the inputted strings would be selected from the history records; and in sequence select from the bookmarks and the preset databases for original addresses and original associational addresses that have webpage links starting with the inputted strings. Original addresses and original associational addresses that have sub-domains starting with the inputted strings would then be selected from the history records, and in sequence select from the bookmarks and the preset databases for original addresses and original associational addresses that have sub-domains starting with the inputted strings.

The history records have stored webpage addresses that the user has visited. The bookmarks are used for storing the original addresses and original associational addresses that users might add to the browser. The preset database stores webpage addresses and is brought through user's installation of the browser application. The preset database could be updated to have hottest webpage addresses to be stored therein.

Step S406, selecting from history records, bookmarks, and preset databases of the local and/or backstage server for the original addresses and original associational addresses having webpage titles that include the inputted strings according to the mapping level.

Specifically, similar to selecting from history records, bookmarks, and preset databases for the webpage addresses having webpage links that include the inputted strings, original addresses and original associational addresses having webpage titles that include the inputted strings are selected from the history records, bookmarks, and preset databases according to the mapping level.

Further, selected webpage addresses are ranked in the order of the mapping level and the selection order from history records, bookmarks, and preset databases.

Furthermore, if the inputted strings are strings without predetermined separator, corresponding original address, search address, original associational address, and search associational address for webpages that respectively include the inputted strings are obtained according to the inputted strings; and subsequently displayed in a suggestion area of the browser.

As an example, if the inputted strings in the address bar of the browser are “baidu”, it is thereby obtained and displayed in the suggestion area of the browser the following contents:

(1) www.baidu.com

(2) search for: baidu

(3) baidu homepage (search associational)

(4) baidu maps (search associational)

If the inputted strings in the address bar of the browser are “sina”, it is thereby obtained and displayed in the suggestion area of the browser the following contents:

(1) sina.com.cn

(2) search for: sina

(3) sina weibo (search associational)

(4) sina homepage (search associational)

Furthermore, if the inputted strings are strings including predetermined separator, corresponding original address, original associational address, search address, and search associational address for webpages that respectively include the inputted strings are obtained according to the inputted strings; and subsequently displayed in a suggestion area of the browser.

Specifically, if the inputted strings are “xxx.xx”, it is thereby obtained and displayed the following contents:

(1) xxx.xx.com

(2) search for: xxx.xx

(3) webpage addresses with formats like xxx.xx*, or 3g.xxx.xx*, or m.xxx.xx*, or webpage addresses having titles including xxx.xx

(4) search for: m.xxx.xx

If the inputted strings are “m.s”, it is thereby obtained and displayed the following contents:

(1) m.s.com

(2) search for: m.s

(3) m.sogou.com

(4) m.suning.com

(5) m.sohu.com

(6) search for: m.sohu

(7) search for: m.sogou

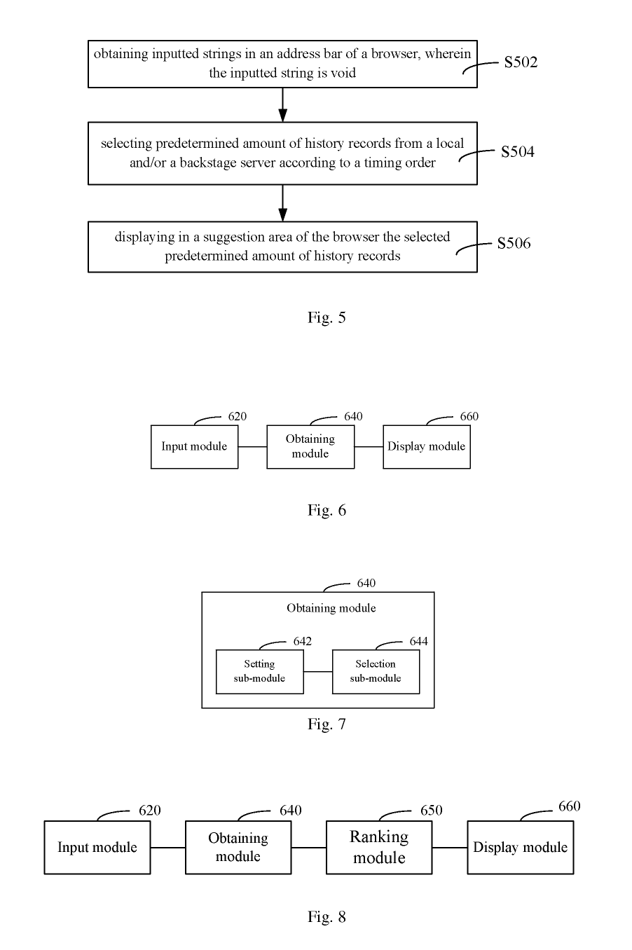

Furthermore, referring to FIG. 5, a method for providing a suggestion for a browser address bar input includes:

Step S502, obtaining inputted strings in an address bar of a browser, wherein the inputted string is void.

Specifically, after launching the browser, the inputted string is void. That is, the user has not inputted any string, predetermined amount of history records could be selected. The predetermined amount could be manually set, for example, to ten (10) or twenty (20).

Step S504, selecting predetermined amount of history records from a local and/or a backstage server according to a timing order.

Step S506, displaying in a suggestion area of the browser the selected predetermined amount of history records.

According to the described method for providing suggestion for browser address bar input, predetermined amount of history records are selected from webpage address history records and search history records and displayed accordingly. Adequate options could therefore be provided.

Referring to FIG. 6, a block diagram for an apparatus for providing a suggestion for a browser address bar input is illustrated. The apparatus includes an input module 620, an obtaining module 640 and a display module 660.

The input module 620 is configured to obtain inputted strings in an address bar of a browser.

In detail, a user launches the browser in the browser, and inputs strings in the address bar thereof through touch screens or press keys. The string could be one of the below types:

(1) String without Predetermined Separator

Specifically, the predetermined separator could be “.” or any separator in a webpage address for separating characters. An example for a string without predetermined separator could be “abc”.

(2) String Including Predetermined Separator

An example for a string with predetermined separator could be “abc.cd”.

(3) String Including Specified Header Character

In detail, the specified header character could be “http:” or “www.”, inclusion of the header character would be indicative that the user is in intension of visiting particular URL.

The obtaining module 640 is configured to obtain primary address and associational address for webpages that respectively include the inputted strings from a local and/or a backstage server.

Specifically, the inputted strings could be, for example, Chinese characters, English characters, numbers, symbols, and the combination thereof. Take an example of inputting strings “xxx”, the primary address for webpages that include the inputted strings could be xxx*.*, while the associational address for webpages that include the inputted strings could be URLs like 3g.xxx* or m.xxx*, wherein “*” indicates a wildcard.

The primary address for webpages that include the inputted strings could be original address and search address for webpages that respectively include the inputted strings. Associational address for webpages that include the inputted strings could be original associational address and search associational address for webpages that respectively include the inputted strings.

The original address is the webpage address that the inputted strings are directly supplemented by characters like .com or .cn. For example, the inputted strings “baidu” could be directly supplemented to be the original address “www.baidu.com”.

The search address shall indicate a search implementation on the inputted strings, and shall mean the webpage address that includes a search result of the inputted strings upon corresponding search implementation is selected. A suggestion for searching the inputted strings is provided, for example, “search for: xxx”. For instance, if the inputted string is “baidu”, corresponding search address shall be, after search implementation on “baidu” is selected, indicative for guiding to a webpage wherein a plurality of searching results on “baidu” are included. After any one of the searching result is selected, corresponding webpage would be able to be accessed.

The original associational address shall mean the webpage address that is obtained through associational suggestion that includes the inputted strings and corresponding associational characters. Taking the inputted strings “m.s” as an example, the original associational address for webpages that include the inputted strings could be m.sohu.com or m.sogou.com, etc.

The search associational address shall mean the webpage address in which multiple associational search results are included through search implementation on the associational inputted strings. For example, the inputted strings are “m.s”, the search associational address is the webpage address in which “m.sohu” is searched. After said “m.sohu” is selected, a webpage including the result for searching “m.sohu” strings could be accessed, and subsequently, after any one of the searching result is selected, corresponding webpage would be able to be accessed.

The display module 660 is configured to display in a suggestion area of the browser the primary address and the associational address.

Specifically, a list that includes the primary address and the associational address would be displayed in the suggestion area of the browser. The suggestion area of the browser preferably could be a determined box area over or below the address bar. The suggestion area could be hidden, after the user inputs strings in the address bar, the suggestion area would display automatically.

Additionally, the primary address and the associational address could be ranked before being displayed. The primary address could be ranked to be in front of the associational address.

According to the described apparatus for providing suggestion for browser address bar input, primary address and associational address for webpages respectively include the inputted strings are obtained according to the inputted strings and displayed accordingly. Adequate options could therefore be provided for users to select from, according to the associational inputted strings.

Furthermore, the input module 620 is further configured to obtain inputted strings in an address bar of a browser, wherein the inputted strings could be strings without predetermined separator or strings including predetermined separator. The obtain module 640 is further configured to obtain original address, search address, original associational address, and search associational address for webpages that respectively include the inputted strings from a local and/or a backstage server. The display module 660 is further configured to display in a suggestion area of the browser the original address, search address, original associational address, and search associational address for webpages that respectively include the inputted strings.

Search associational address shall mean the webpage address in which multiple search result on the inputted strings and the associational strings thereof are included. For example, the inputted strings are “baidu”, the associational strings thereof could be “maps”, and a search on “baidu maps” would accordingly be suggested with the format “search for: baidu maps”. If selected, a search result webpage would be accessed, and many webpage addresses that are corresponding to the search results would be presented, such as the webpage address for “baidu maps”, the wiki webpage address for “baidu maps”, etc.

Additionally, if the inputted strings are strings including predetermined separator, associational strings would be separately obtained through associating strings before and after the predetermined separator. First, setting up associational database; after the obtaining module 640 obtains the strings including predetermined separator, the strings are divided into first strings and second strings respectively before and after the predetermined separator. First associational strings for the first strings and second associational strings for the second strings would subsequently be obtained from the associational database according to the first and second strings. Accordingly, original associational address and search associational address including the first strings and the first associational strings, the predetermined separator, and the second strings and the second associational strings would be concluded.

Furthermore, the input module 620 is further configured to obtain inputted strings in an address bar of a browser, wherein the inputted strings are strings including specified header character. The obtaining module 640 is further configured to obtain original address and original associational address for webpages that respectively include the inputted strings from a local and/or a backstage server. The display module 660 is further configured to display in a suggestion area of the browser the original address and original associational address for webpages that respectively include the inputted strings.

Furthermore, the obtaining module 640 is further configured to obtain original address and original associational address for webpages that respectively include the inputted strings in webpage links or webpage titles thereof from a local and/or a backstage server. Referring to FIG. 7, the obtaining module 640 includes a setting sub-module 642 and a selection sub-module 644. Wherein:

The setting sub-module 642 is configured to set mapping level respectively for webpage links and webpage titles to include the inputted strings.

Specifically, the setting sub-module 642 would set the mapping level for domain name for a webpage link that starts with the inputted strings to be higher than the mapping level for sub-domains for a webpage link that starts with the inputted strings; and would set the mapping level for a webpage title that starts with the inputted strings to be higher than the mapping level for webpage titles that include the inputted strings.

The selection sub-module 644 is configured to select from history records, bookmarks, and preset databases of the local and/or backstage server for the original addresses and the original associational addresses having webpage links that include the inputted strings according to the mapping level; and for selecting from history records, bookmarks, and preset databases of the local and/or backstage server for the original addresses and original associational addresses having webpage titles that include the inputted strings according to the mapping level.

Specifically, either the local or the backstage server would include history records for webpage addresses. The history records include original records and search records. The original records stores webpage addresses that the user has visited, including the original address and the original associational address. The search records stores webpage addresses for the searches that the user has conducted, including the search address and the search associational address.

Original addresses and original associational addresses that have webpage links starting with the inputted strings would be selected from the history records; and in sequence select from the bookmarks and the preset databases for original addresses and original associational addresses that have webpage links starting with the inputted strings. Original addresses and original associational addresses that have sub-domains starting with the inputted strings would then be selected from the history records, and in sequence select from the bookmarks and the preset databases for original addresses and original associational addresses that have sub-domains starting with the inputted strings.

The history records have stored webpage addresses that the user has visited. The bookmarks are used for storing the original addresses and original associational addresses that users might add to the browser. The preset database stores webpage addresses and is brought through user's installation of the browser application. The preset database could be updated to have hottest webpage addresses to be stored therein.

Referring to FIG. 8, according to another embodiment, the apparatus for providing a suggestion for a browser address bar input includes an input module 620, an obtaining module 640, a display module 660, and further a ranking module 650.

The ranking module 650 is configured to rank selected webpage addresses in the order of the mapping level and the selection order from history records, bookmarks, and preset databases.

According to another embodiment, in the apparatus for providing suggestion for browser address bar input, the input module 620 is further configured to obtain inputted strings in an address bar of a browser, wherein the inputted string is void.

Specifically, after launching the browser, the inputted string is void. That is, the user has not inputted any string, predetermined amount of history records could be selected. The predetermined amount could be manually set, for example, to ten (10) or twenty (20).

The obtaining module 640 is further configured to select predetermined amount of history records according to a timing order.

The display module 660 is further configured to display in a suggestion area of the browser the selected predetermined amount of history records.

Besides, it is provided by the present disclosure a browser which includes the above described apparatus for providing suggestion for browser address bar input.

Those skilled in the art could be able to understand that the above method, whether as a whole or part thereof, would be implemented through particular hardware under the instruction of computer and/or mobile terminal executable programs; which program is stored in computer readable medium that, the above steps of the methods would be included when the program is executed. The computer readable medium shall include hard disk, optical disk, Read-Only Memory (ROM) or Random Access Memory (RAM), etc.

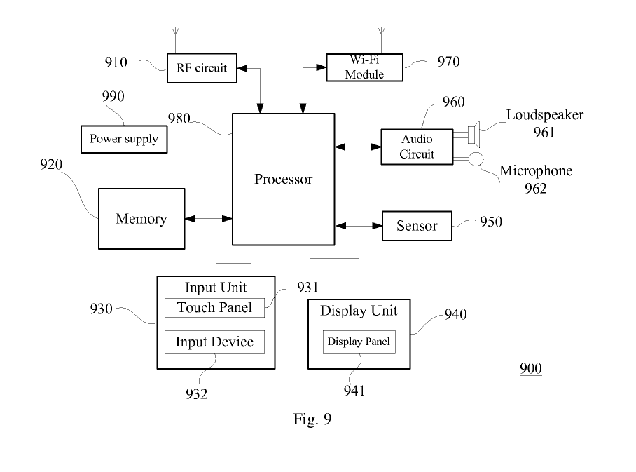

It is also provided by another embodiment of the present disclosure an apparatus for providing a suggestion for a browser address bar input as illustrated in FIG. 9. For simply the description, only the corresponding parts in relation with the present embodiment would be described; other reference would be taken to the description of the method above. The terminal herein could be mobile phone, tablet computer, personal digital assistant (PDA), point of sales (POS), onboard computer, etc. The following description would take mobile phone as an example.

A block diagram of part of a mobile phone in accordance with the terminal of an embodiment of the present disclosure is illustrated in FIG. 9. Referring to FIG. 9, the mobile phone 900 includes: radio frequency (RF) circuit 910, memory 920, input unit 930, display unit 940, sensor 950, audio circuit 960, Wi-Fi module 970, processor 980, and power supply 990. It is appreciated that, the structure as illustrated in FIG. 9 would not limit the mobile phone; the mobile phone would rather have less or more components, or any component combination, or alternative arrangement thereof.

The components of the mobile phone are described with reference to FIG. 9 as below.

The RF circuit 910 is configured to transmit and receiving messages or receiving and sending signals during a call. Specifically, downlink messages are received and processed by the processor 980. Besides, uplink data is transmitted to the base. Usually, the RF circuit 910 includes but not limited to antenna, at least one amplifier, transceiver, coupler, low noise amplifier (LNA), duplexer, etc. Besides, the RF circuit 910 is configured to communicate with other devices through wireless communication networks. The wireless communication could be conducted on any of the communication standards or protocols, including but not limited to Global System of Mobile communication (GSM), General Packet Radio Service (GPRS), Code Division Multiple Access (CDMA), Wideband Code Division Multiple Access (WCDMA), Long Term Evolution (LTE), email, Short Message Service (SMS), etc.

The memory 920 is configured to store software programs and modules. The processor operates the software programs and modules that are stored in the memory 920 to provide multiple functionality applications and data processes of the mobile phone. The memory 920 could include a program segment and a data segment, wherein the program segment is configured to store operating system, application program required for at least one functionality (such as audio play, video play, etc.); the data segment is configured to store data that are required and generated during the operation of the mobile phone (for example audio data, contact list, etc.) Besides, the memory 920 could include high speed random access memory, or non-volatile memory, such as at least one disk storage device, flash memory device, or other non-volatile solid state memory device.

The input unit 930 is configured to receive inputted number or character information, and correspondingly generating signal input that relates to the user configuration and functional control of the mobile phone. Specifically, the input unit 930 can include touch panel 931 or other input device 932. The touch panel 931 could also be a touch screen, configured to collect users' touch operations on and around (for example users operate on or around the touch panel 931 through fingers, touch pens, or other appropriate objects or accessories), and for driving corresponding connected devices according to the preset programs. Optionally, the touch panel 931 could include touch detect device and touch controller. The touch detect device is configured to detect the touched position, and detecting the touch signal brought up by the touch operation, and transmitting the touch signal to the touch controller. The touch controller receives the touch signal from the touch detect device and transform into touch point coordinates to be transmitted to the processor 980. The touch controller is further configured to receive commands sent from the processor 980 and executing the commands. The touch panel 931 could be of resistive, capacitive, infrared, surface acoustic wave kinds, etc. Besides the touch panel 931, the input unit 930 may include other input devices 932. Specifically, the other input device 932 could include but not limited to one or more of physical keyboard, functional key (such as volume key, power button, etc.), track ball, mouse, or joystick, etc.

The display unit 940 is configured to display messages that the user inputs or messages that are provided to the user, or other menus of the mobile phone. The display unit 940 can include a display panel 941. Optionally, the display panel 941 could be configured through Liquid Crystal Display (LCD), Organic Light-Emitting Diode (OLED), etc. Furthermore, the touch panel 931 could be configured to cover the display panel 941. When the touch panel 931 detects the touch operation on or around and transmitted to the processor 980 for determining a type of the touch operation, the processor 980 would provide corresponding visual output on the display panel 941 according to the determined type of touch operation. Although the touch panel 931 and the display panel 941 are provided as separate components in FIG. 9 for providing input and display functions of the mobile phone, in other alternative embodiment, the touch panel 931 and the display panel 941 could be integrated together to provide the input and output function for the mobile phone.

The mobile phone 900 could include at least one sensor 950, for example, a light sensor, a motion sensor, and other sensors. Specifically, the light sensor would include an environmental light sensor and an approaching sensor. The environmental light sensor could be configured to adjust a lightness of the display panel 941 according to an environmental luminance. The approaching sensor can switch off the display panel 941 and/or backlight thereof when the mobile phone is approaching ears of the users. As an example of the motion sensor, an accelerometer sensor is able to detect accelerations on each dimension (usually three dimensions), and while kept still would be able to detect the gravity and the direction thereof; thereby it is configured to be provided in applications for recognizing mobile phone postures (for example switch between horizontal and perpendicular, related games, magnetometer position calibration, etc.), or in vibration identification related functions (such as pedometer, knocking) etc. Other sensors like gyroscope, barometer, hygrometer, thermometer, infrared sensor would be configured to the mobile phone, and would not be described here.

The audio circuit 960, a loudspeaker 961, and a microphone 962 are configured to provide an audio interface between the user and the mobile phone. The audio circuit 960 is configured to transmit received electronic signals that are converted from audio data to the loudspeaker 961, thereby the loudspeaker 961 would have the electronic signals transformed into audio signals to be sent out. On the other hand, the microphone 962 converts received audio signals into electronic signals that are subsequently to be received by the audio circuit 960 and have them transformed into audio data. The processor 980 receives and processes the audio data before sending out through the RF circuit 910, for example to another mobile phone. The audio data could also be sent to the memory 920 to be stored for further process.

Wi-Fi is a sort of short distance wireless transmission technology. Through the Wi-Fi module 970, the mobile phone is able to help users to send and receive emails, browse the web, and visit streaming media, etc. The wireless broadband internet access is thereby provided to the user. It is appreciated that although the Wi-Fi module 970 is provided in the embodiment as FIG. 9, it would not constitute an essential part of the mobile phone 900, and would be eliminated according to user's demand while keeping the spiritual scope of the present disclosure.

The processor 980 may be considered to be the control center of the mobile phone. The processor 980 is connected to each part of the mobile phone through various interfaces and routes. Through operating or executing software programs and/or modules that are stored in the memory 920, and through calling data that is stored in the memory, the processor 980 is able to execute the functionalities of the mobile phone as well as process data, thereby monitors the mobile phone as a whole. Preferably, the processor 980 may include one or more processing units. Preferably, the processor 980 may have application processor and modulation and demodulation processor that are integrated together. Wherein, the application processor is mainly used for processing operating system, user interface, and the applications; while the modulation and demodulation processor mainly processes wireless communications. It would be appreciated that, the modulation and demodulation processor would alternatively not be integrated in the processor 980.

The mobile phone 900 further includes the power supply 990 for providing power for the components (for instance battery). Preferably, the power supply 990 could be logically connected to the processor 980 through a power management system, thereby functions like charging, discharging, and power consumption could be managed through the power management system.

Although not presented, the mobile phone 900 may, for example, further include a camera, a Bluetooth module, etc., which are not described here.

According to the present embodiment, the processor 980 of the terminal may be configured to execute a method for providing suggestions for browser address bar input, which includes:

obtaining inputted strings in an address bar of a browser;

obtaining address for webpage that includes the inputted strings, search of the inputted strings, and associational address for webpage that includes the inputted strings, according to the inputted strings;

displaying in a suggestion area of the browser the address for webpage that includes the inputted strings, search of the inputted strings, and associational address for webpage that includes the inputted strings.

Further, the processor 980 of the terminal may be configured to:

obtain search associational strings according to the inputted strings;

display in a suggestion area of the browser the search associational strings.

Furthermore, the processor 980 of the terminal is configured to:

obtain addresses that include the inputted strings from history records, and/or searches that included the inputted strings from history searches;

display in a suggestion area of the browser the addresses that include the inputted strings from history records, and/or searches that included the inputted strings from history searches.

Furthermore, the processor 980 of the terminal may be configured to:

if the inputted strings are strings without predetermined separator, corresponding original address, obtain address for webpage that includes the inputted strings, search of the inputted strings, associational address for webpage and search association that includes the inputted strings, and history searches that include the inputted strings, according to the inputted strings;

display in a suggestion area of the browser the address for webpage that includes the inputted strings, search of the inputted strings, associational address for webpage and search association that includes the inputted strings, and history searches that include the inputted strings.

Furthermore, the process 980 of the terminal may be configured to:

obtain addresses for webpages that include the inputted strings in webpage links or webpage titles thereof, which includes:

set mapping level respectively for webpage links and webpage titles to include the inputted strings;

select from history records, bookmarks, and preset databases for the addresses for webpages having webpage links that include the inputted strings according to the mapping level;

select from history records, bookmarks, and preset databases for the addresses for webpages having webpage titles that include the inputted strings according to the mapping level.

Furthermore, the processor 980 of the terminal may be further configured to set mapping level respectively for webpage links and webpage titles to include the inputted strings, wherein the processor 980 may be further configured to:

set the mapping level for domain name for a webpage link that starts with the inputted strings to be higher than the mapping level for sub-domains for a webpage link that starts with the inputted strings;

set the mapping level for a webpage title that starts with the inputted strings to be higher than the mapping level for webpage titles that include the inputted strings.

Furthermore, the processor 980 of the terminal may be further configured to:

rank selected webpage addresses in the order of the mapping level and the selection order from history records, bookmarks, and preset databases.

The above described embodiments explain only several exemplary embodiments of the present disclosure. It shall be mentioned that for those skilled in the art, alternative embodiments could be made to which the present disclosure pertains without departing from its spirit and scope, wherein the alternative embodiments shall be defined as within the claim of the current disclosure.

What is claimed is:

1. A method comprising:
obtaining a string input in an address bar of a browser;
obtaining at least one primary address and at least one associational address for webpages that respectively include the string from a local and/or a backstage server; and
displaying in a suggestion area of the browser the at least one primary address and the at least one associational address.

2. The method according to claim 1, wherein the at least one primary address comprises an original address and a search address for webpages that respectively include the string; and the at least one associational address comprises an original associational address and a search associational address for webpages that respectively include the string.

3. The method according to claim 2, wherein if the string is a string without a predetermined separator or a string including a predetermined separator, said obtaining at least one primary address and at least one associational address comprises:
obtaining an original address, a search address, an original associational address, and a search associational address for webpages that respectively include the string from the local and/or the backstage server;
wherein said displaying comprises:
displaying in the suggestion area the original address, the search address, the original associational address, and the search associational address.

4. The method according to claim 2, wherein if the string is a string including a specified header character, said obtaining at least one primary address and at least one associational address comprises:
obtaining the original address and the original associational address from the local and/or the backstage server;
wherein said displaying comprises:
displaying in the suggestion area the original address and the original associational address obtained by said obtaining the original address and the original associational address.

5. The method according to claim 4, wherein
said obtaining the original address and the original associational address comprises:
obtaining a plurality of original addresses and a plurality of original associational addresses for webpages that respectively include the string in webpage links or webpage titles thereof;
and the method further comprises:
setting mapping levels respectively for the webpage links and the webpage titles;
selecting an original address of the plurality of original addresses and an original associational address of the plurality of original associational addresses having webpage links that include the string from history records, bookmarks, and preset databases of the local and/or backstage server, according to the mapping levels; and
selecting an original address of the plurality of original addresses and an original associational address of the plurality of original associational addresses having webpage titles that include the input string from the history records, the bookmarks, and the preset databases of the local and/or backstage server, according to the mapping levels.

6. The method according to claim 5, wherein said setting mapping levels comprises:
setting a mapping level for a domain name for a webpage link that starts with the string to be higher than a mapping level for sub-domains for a webpage link that starts with the string;
setting a mapping level for a webpage title that starts with the string to be higher than a mapping level for webpage titles that include the string.

7. The method according to claim 6, wherein the method further comprises:
ranking selected webpage addresses in an order of the mapping levels and a selection order from the history records, bookmarks, and preset databases.

8. A method comprising:
selecting, when a user has not input a string into an address bar of a browser that has been launched, a predetermined amount of history records from a local and/or a backstage server according to a timing order; and
displaying, in a suggestion area of the browser, the selected predetermined amount of history records.

9. An apparatus comprising:
an input module configured to obtain a string input in an address bar of a browser;
an obtaining module configured to obtain at least one primary address and at least one associational address for webpages that respectively include the string from a local and/or a backstage server;
a display module configured to display, in a suggestion area of the browser, the at least one primary address and the at least one associational address.

10. The apparatus according to claim 9, wherein the at least one primary address comprises an original address and a search address for webpages that respectively include the string; and the at least one associational address comprises an original associational address and a search associational address for webpages that respectively include the string.

11. The apparatus according to claim 10, wherein if the string is a string without a predetermined separator or a string including a predetermined separator, the obtain module is further configured to obtain an original address, a search address, an original associational address, and a search associational address for webpages that respectively include the string from the local and/or the backstage server; and
the display module is further configured to display, in the suggestion area, the original address, the search address, the original associational address, and the search associational address.

12. The apparatus according to claim 10, wherein if the string is a string including specified header character, the obtaining module is further configured to obtain the original address and the original associational address from the local and/or the backstage server; and
the display module is further configured to display, in the suggestion area, the original address and the original associational address obtained by the obtaining module.

13. The apparatus according to claim 10, wherein the obtaining module is further configured to obtain a plurality of original address and a plurality of original associational address for webpages that respectively include the string in webpage links or webpage titles thereof, and the obtaining module further comprising:
a setting sub-module configured to set mapping levels respectively for the webpage links and the webpage titles;
a selection sub-module configured to select an original address of the plurality of original addresses and an original associational address of the plurality of original associational addresses having webpage links that include the string from history records, bookmarks, and preset databases of the local and/or the backstage server, according to the mapping levels; and to select an original address of the plurality of original addresses and an original associational address of the plurality of original associational addresses having webpage titles that include the input string from history records, bookmarks, and preset databases of the local and/or the backstage server, according to the mapping levels.

14. The apparatus according to claim 13, wherein the setting sub-module is further configured to set a mapping level for a domain name for a webpage link that starts with the string to be higher than a mapping level for sub-domains for a webpage link that starts with the string; and to set a mapping level for a webpage title that starts with the string to be higher than a mapping level for webpage titles that include the string.

15. The apparatus according to claim 14, wherein the apparatus further comprises:
a ranking module configured to rank selected webpage addresses in an order of the mapping levels and a selection order from the history records, bookmarks, and preset databases.
